(19) United States
(12) Patent Application Publication
(10) Pub. No.: US 2018/0040093 A1
(43) Pub. Date: Feb. 8, 2018

(54) Vehicle request using wearable earpiece

(71) Applicant: BRAGI GmbH, München (DE)

(72) Inventor: Peter Vincent Boesen, München (DE)

(73) Assignee: BRAGI GmbH, München (DE)

(21) Appl. No.: 15/666,957

(22) Filed: Aug. 2, 2017

Related U.S. Application Data
(60) Provisional application No. 62/370,242, filed on Aug. 3, 2016.

(51) Int. Cl. G06Q 50/30; H04R 1/10; G01C 21/16; G05D 1/00; G01C 21/34; G01C 21/20

(52) U.S. Cl. CPC G06Q 50/30; G01C 21/3438; G01C 21/206; G01C 21/16; G05D 1/0088; H04R 1/1091; H04W 12/06

(57) ABSTRACT

A system includes a vehicle, the vehicle comprising a control system and a wireless transceiver operatively connected to the control system. The control system is configured to wirelessly communicate with a wearable device worn by a user using the wireless transceiver and the control system is configured to receive input from one or more sensors of the wearable device. A method includes receiving at an earpiece a request for a vehicle from a user, verifying identity of the user by the earpiece, and communicating the request to a vehicle or vehicle operator.

### PRIORITY STATEMENT

This application claims priority to U.S. Provisional Patent Application 62/370,242, filed on Aug. 3, 2016, and entitled “Vehicle with wearable integration or communication”, hereby incorporated by reference in its entirety.

### FIELD OF THE INVENTION

The present invention relates to vehicles. More particularly, but not exclusively, the present invention relates to a vehicle which integrates with or communicates with a wearable device such as an earpiece or a set of earpieces.

### BACKGROUND

Vehicles such as automotive vehicles may be expensive to purchase and maintain. This is particularly true for many individuals who may own vehicles but use the vehicles a limited amount and when the cost of each use of the vehicle is determined. Another issue is that owning a vehicle can be inconvenient for a variety of reasons. For example, in a large city a great deal of time can be spent looking for a parking spot, in addition to maintaining the vehicle with scheduled maintenance.

What is needed are technologies which allow for more efficient use of vehicles on an individual as well as societal manner.

### SUMMARY

Therefore, it is a primary object, feature, or advantage of the present invention to improve over the state of the art.

It is another object, feature, or advantage of the present invention to communicate between vehicle systems and wearable devices such as earpieces.

It is a further object, feature, or advantage of the present invention to allow a user to control one or more functions of a vehicle using one or more wearable devices such as ear pieces.

A still further object, feature, or advantage is to allow a user to request a vehicle using an earpiece, the request being for an autonomous vehicle, a ride share vehicle, a rental vehicle, a taxi or limousine service, their own vehicle, or other type of vehicle request.

A further object, feature, or advantage of the present invention is to allow a user to use an earpiece to facilitate rapid pickup by a vehicle or service.

A still further object, feature, or advantage is to use biometric sensing for sleep, heart rate variability (HRV), and other biometric factors to authenticate identity of a user making a request for a vehicle.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to another aspect, a method includes receiving at an earpiece a request for a vehicle from a user, verifying identity of the user by the earpiece, and communicating the request to a vehicle or vehicle operator. The request may be a request to rent a vehicle, a request to be picked up by the vehicle or a driver of the vehicle, or an autonomous vehicle. The verifying may be performed using biometric data collected using one or more sensors of the earpiece. The biometric data includes biometric data sensed with a pulse oximeter of the earpiece. The biometric data includes heart rate variability. The method may further include providing turn-by-turn directions to the user through the earpiece. The request may be in the form of a voice request such as to a smart assistant of the earpiece or otherwise.

According to another aspect, a method includes detecting at an earpiece a voice request from a user of the earpiece for access to a vehicle, verifying an identity of the user, wherein the verifying the identify is performed by the earpiece, sending a request from the earpiece over a network, the request including the identity of the user and a user location, receiving over the network a location associated with the vehicle, and providing audio prompts through the earpiece to direct the user along a route to the location associated with the vehicle from the user location. The vehicle may be an autonomous vehicle, a ride share vehicle, a taxi, or other vehicle. The location may be a rendezvous location between the user and the vehicle. The rendezvous location may be a location different from the current location of the vehicle.

### BRIEF DESCRIPTION OF THE DRAWINGS

FIG. 1 illustrates one example of a vehicle which integrates with wearable technology.

FIG. 2 illustrates one example of a set of wearable devices in the form of ear pieces.

FIG. 3 is a block diagram of one example of a wearable device in the form of an earpiece.

FIG. 4 illustrates an example of communications between a wearable earpiece and a vehicle.

### DETAILED DESCRIPTION

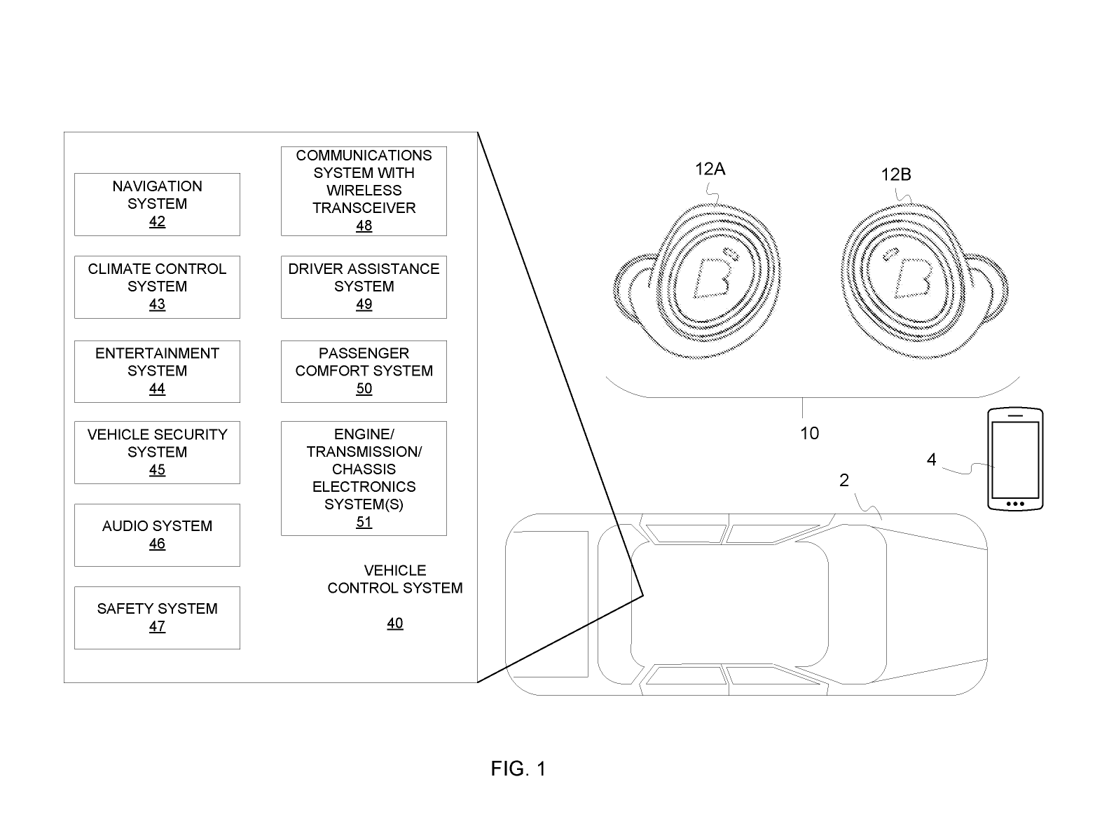

FIG. 1 illustrates one example of use of a wearable device in conjunction with a vehicle. A shown in FIG. 1 there is a vehicle 2. Although the vehicle shown is a full-size sedan, it is contemplated that the vehicle may be of any number of types of cars, trucks, sport utility vehicles, vans, mini-vans, automotive vehicles, commercial vehicles, agricultural vehicles, construction vehicles, specialty vehicles, recreational vehicles, buses, motorcycles, aircraft, boats, ships, yachts, spacecraft, or other types of vehicles. The vehicle may be gas-powered, diesel powered, electric, solar-powered, or human-powered. The vehicle may be actively operated by a driver or may be partially or completely autonomous or self-driving. The vehicle 2 may have a vehicle control system 40. The vehicle control system is a system which may include any number of mechanical and electromechanical subsystems. As shown in FIG. 1, such systems may include a navigation system 42, an entertainment system 44, a vehicle security system 45, an audio system 46, a safety system 47, a communications system 48 preferably with a wireless transceiver, a driver assistance system 49, a passenger comfort system 50, and an engine/transmission, chassis electronics system(s) 51. Of course, other examples of vehicle control sub-systems are contemplated. In addition, it is to be understood that there may be overlap between some of these different vehicle systems and the presence or absence of these vehicle systems as well as other vehicle systems may depend upon the type of vehicle, the type of fuel or propulsion system, the size of the vehicle, and other factors and variables. In the automotive context, examples of the driver assistance system 49 may include one or more subsystems such as a lane assist system, a speed assist system, a blind spot detection system, a park assist system, and an adaptive cruise control system. In the automotive context, examples of the passenger comfort system 50 may include one or more subsystems such as automatic climate control, electronic seat adjustment, automatic wipers, automatic headlamps, and automatic cooling. In the automotive context, examples of the safety system 47 may include active safety systems such as air bags, hill descent control, and an emergency brake assist system. Aspects of the navigation system 42, the entertainment system 44, the audio system 46, and the communications system 48 may be combined into an infotainment system.

One or more wearable devices such as a set of earpieces 10 including a left earpiece 12A and a right earpiece 12B may in operative communication with the vehicle control system 40 such as through the communication system 48. For example, the communication system 48 may provide a Bluetooth or BLE link to wearable devices or may otherwise provide for communications with the wearable devices preferably through wireless communications. The vehicle 2 may communicate with the wearable device(s) directly, or alternatively, or in addition, the vehicle 2 may communicate with the wearable device(s) through an intermediary device such as a mobile device 4 which may be a mobile phone, a tablet, or other type of mobile device.

The wearable device(s) 10 interact with the vehicle control system 40 in any number of different ways. For example, the wearable device(s) 10 may provide sensor data, identity information, stored information, streamed information, or other types of information to the vehicle. Based on this information, the vehicle may take any number of actions which may include one or more actions taken by the vehicle control system (or subsystems thereof). In addition, the vehicle 2 may communicate sensor data, identity information, stored information, streamed information or other types of information to the wearable device(s) 10.

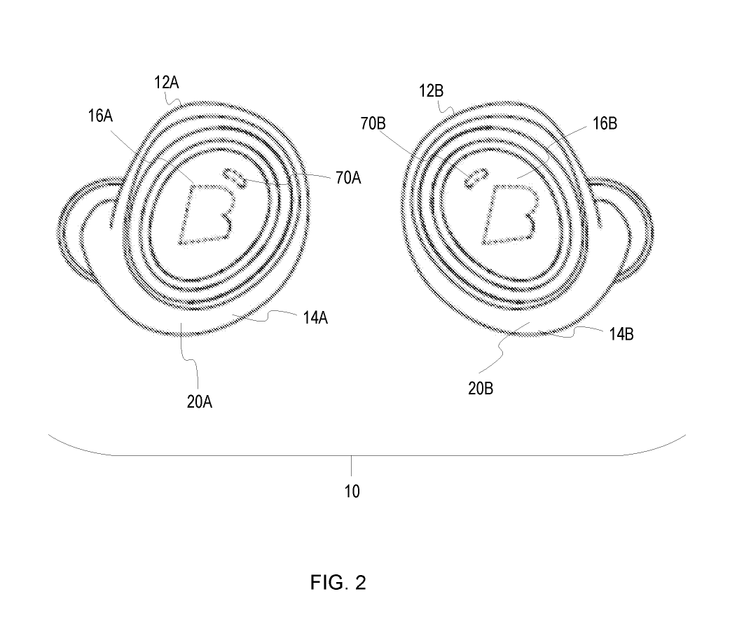

FIG. 2 illustrates one example of a wearable device in the form of a set of ear pieces 10 in greater detail. FIG. 1 illustrates a set of earpiece wearables 10 which includes a left earpiece 12A and a right earpiece 12B. Each of the earpieces wearables 12A, 12B has an earpiece wearable housing 14A, 14B which may be in the form of a protective shell or casing and may be an in-the-ear earpiece housing. A left infrared through ultraviolet spectrometer 16A and right infrared through ultraviolet spectrometer 16B is also shown. Each earpiece 12A, 12B may include one or more microphones 70A, 70B. Note that the air microphones 70A, 70B are outward facing such that the air microphones 70A, 70B may capture ambient environmental sound. It is to be understood that any number of microphones may be present including air conduction microphones, bone conduction microphones, or other audio sensors.

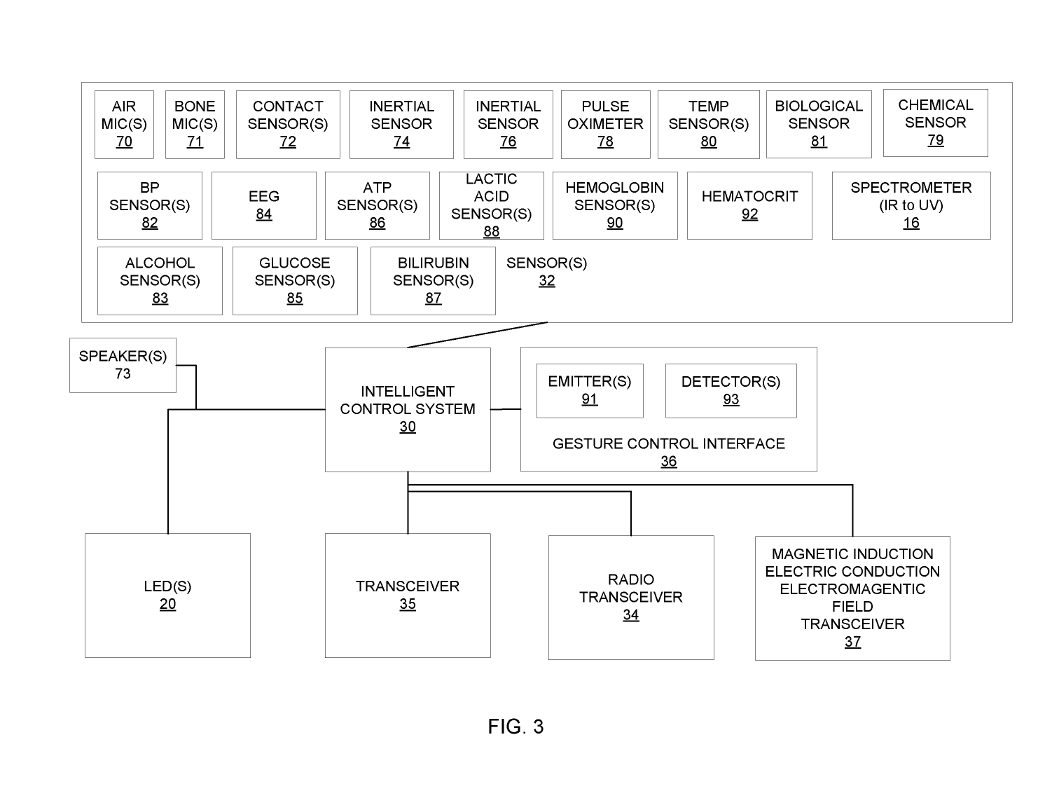

FIG. 3 is a block diagram illustrating a device. The device may include one or more LED(s) 20 electrically connected to an intelligent control system 30. The intelligent control system 30 may include one or more processors, microcontrollers, application specific integrated circuits, or other types of integrated circuits. The intelligent control system 30 may also be electrically connected to one or more sensors 32. Where the device is an earpiece, the sensor(s) may include an inertial sensor 74, another inertial sensor 76. Each inertial sensor 74, 76 may include an accelerometer, a gyro sensor or gyro meter, a magnetometer or other type of inertial sensor. The sensor(s) 32 may also include one or more contact sensors 72, one or more bone conduction microphones 71, one or more air conduction microphones 70, one or more chemical sensors 79, a pulse oximeter 78, a temperature sensor 80, or other physiological or biological sensor(s). Further examples of physiological or biological sensors include an alcohol sensor 83, glucose sensor 85, or bilirubin sensor 87. Other examples of physiological or biological sensors may also be included in the device. These may include a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor.

A spectrometer 16 is also shown. The spectrometer 16 may be an infrared (IR) through ultraviolet (UV) spectrometer although it is contemplated that any number of wavelengths in the infrared, visible, or ultraviolet spectrums may be detected. The spectrometer 16 is preferably adapted to measure environmental wavelengths for analysis and recommendations and thus preferably is located on or at the external facing side of the device.

A gesture control interface 36 is also operatively connected to or integrated into the intelligent control system 30. The gesture control interface 36 may include one or more emitters 91 and one or more detectors 93 for sensing user gestures. The emitters may be of any number of types including infrared LEDs. The device may include a transceiver 35 which may allow for induction transmissions such as through near field magnetic induction. A short range transceiver 34 using Bluetooth, BLE, UWB, or other means of radio communication may also be present. The short range transceiver 34 may be used to communicate with the vehicle control system. In operation, the intelligent control system 30 may be configured to convey different information using one or more of the LED(s) 20 based on context or mode of operation of the device. The various sensors 32, the processor or other intelligent control system 30, and other electronic components may be located on the printed circuit board of the device. One or more speakers 73 may also be operatively connected to the intelligent control system 30.

A magnetic induction electric conduction electromagnetic (E/M) field transceiver 37 or other type of electromagnetic field receiver is also operatively connected to the intelligent control system 30 to link the processor 30 to the electromagnetic field of the user. The use of the E/M transceiver 37 allows the device to link electromagnetically into a personal area network or body area network or other device.

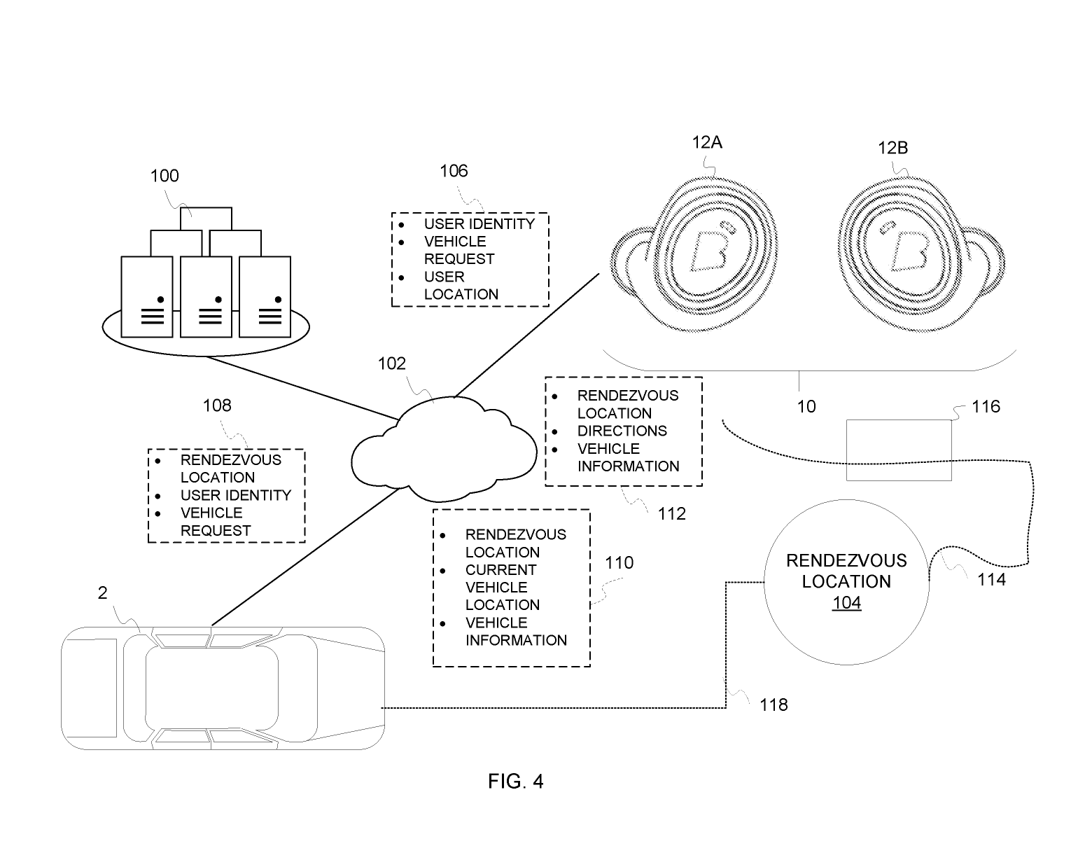

FIG. 4 illustrates one example of a set of earpieces 10 including earpieces 12A, 12B. One or more of the earpieces 12A, 12B may communicate over a network 102 to one or more servers 100. The earpiece 12A, 12B may communicate information over the network such as a user identity. The earpiece 12A, 12B may have already determined the user identity or verified the identity of the user such as by using biometric information of the user to verify. The earpiece 12A, 12B may detect a voice request from the user of the earpiece, the voice request being a request for access to a vehicle. The access to the vehicle may be a request to rent a vehicle, a request for a ride share, a request for a taxi, a request for an autonomous vehicle, including one that the user owns or controls. Based on the voice request, the earpiece may process the voice request to determine a request for a vehicle. The request for the vehicle or vehicle request may be accompanied by the user identity, and/or the user location. Data 106 is illustrative of data which may be communicated from the earpiece over the network 102. The earpiece may in return receive a location associated with the vehicle which may be a rendezvous location or a current location. Data 112 is illustrative of information which may communicated over the network to the earpiece and may further include vehicle information such as make, model, color, or other information.

It is contemplated that at least portions of the information and coordination of the process may occur at the servers 100 or other computing platform. In addition, the wireless earpiece 12A, 12B may communicate with an app executing on a mobile device such as a phone (not shown) as an intermediary which may be used to display information. The vehicle 2 may receive data 108 including rendezvous location, user identity, and the vehicle request. The vehicle 2 may send or share data 110 such as the rendezvous location, current vehicle location, or vehicle information. This sharing may occur through the server 100, or other computing device operatively connected to the network 102.

As shown in FIG. 4, either the servers 100 or the vehicle 2, mobile device, earpiece 12A, 12B, or other computing device operatively connected to the network 102 may compute a path 114 for the user to take to a rendezvous location 104. The path 114 may be walked by the user or alternatively may include swimming, biking, or mass transit segments. The path 114 may also transit through a building 116. As previously explained, the earpiece 12A, 12B may include one or more inertial sensors. The inertial sensors may be used to assist in determining the location of the user when other means of location are not available. Thus, for example, if the earpieces 12A, 12B are in wireless communication with a mobile phone with GPS, the GPS location of the mobile phone may be used to determine user location. However, when GPS service is not available, the location of the user may be determined based on the last available GPS location as modified by movement of the user as determined by one or more inertial sensors. Location of a user may be determined in other ways including by prompting the user for a location such as a street address. Audio prompts may be provided through the earpiece to direct the user along the path 114 to the location associated with the vehicle from the user location including the rendezvous location 104. The vehicle may also travel along a path 118 calculated by the vehicle 2, the sever or platform 100, or one or more other computing devices operatively connected to the network 102.

The audio prompts may be provided by a voice assistant for providing instructions to the users. The one or more earpieces may not have a geolocation system such as a global positioning system (GPS) receiver or GLOSNASS receiver or other geolocation system. However, the one or more earpieces may each have one or more inertial sensors which may be used to track movement of an individual. Thus, to determine geolocation or geospatial position, the one or more wearable devices may communicate with a mobile device or vehicle navigation system which includes a geolocation system. It is further contemplated that once an earpiece knows of or is calibrated to a particular geoposition, the earpiece may use information from its inertial sensors to update or track changes in its geoposition.

For example, when an individual is sitting in a vehicle (or otherwise proximate the vehicle), the earpiece may request and/or receive geoposition information from the vehicle. Thus, the earpiece may use the geoposition to calibrate or re-calibrate itself to an accurate geoposition. It is contemplated that the more precise the geoposition information, the more precise the position the individual should be located at when calibrating and that there be an appropriate offset between the position of the GPS antenna of the vehicle and the position of the earpieces(s) (or other wearable device). Similarly, a geolocation stored in an earpiece may be calibrated to a GPS location of a mobile device such as a phone.

As previously explained, the earpiece 12A, 12B may communicate information over the network such as a user identity. The earpiece 12A, 12B may have already determined the user identity or verified the identity of the user such as by using biometric information of the user to verify. Each earpiece 12A, 12B may be used to determine or confirm identity of an individual wearing it. This may be accomplished in various ways including through voice imprint. In particular, an individual may speak and their voice analyzed by the earpiece 12A, 12B and compared to known samples or metrics in order to identify the individual. This may include measures of voice shimmer rates, or voice jitter rates. Similarly, an individual may be asked to specify other information to the earpiece in order to confirm identity. For example, a user may be requested to provide passwords or pass phrases, or to answer questions that only the user is expected to answer correctly. Where other physiological sensors are used, these sensors may be used to verify the user. For example, heart rate variability as measured by a pulse rate sensor or pulse oximeter may be used to verify the identity of the user. The identity of the user may be verified by the earpiece. For example, a digital signal processor or other aspect of the intelligent control system within the earpiece may sample sensor data and perform the appropriate analysis including comparisons of information from sampled data and information previously stored. It is further contemplated that a vehicle may require additional verification once the user arrives at the vehicle, however, lesser levels of security may be needed to make the vehicle request. The earpiece may also communicate its own identity such as its own unique identifier to identify the earpiece.

The wearable devices may be used in car sharing applications such as DriveNow or drive sharing applications such as Uber, Lyft, Didi Chuxing. or others. In such an application, one or more earpieces (or other wearable devices) may be used to communicate directly with an individual in order to receive a reservation request for a vehicle or a request for a ride or other vehicle request. Confirmation of the vehicle request may be made through the earpiece by providing audible confirmation. In addition, payment may be made through the vehicle. For example, payment information such as credit card information or bank account information may already be stored in a system. Then payment may be made using the stored payment information. An authentication process may be used to confirm identity of the user. The authentication process may take any number of different forms. For example, the authentication process may use biometric authentication. A voice sample of the user may be taken and compared to other voice samples of a particular individual or voice profiles of a particular individual. Fundamentally, frequencies of the voice including jitter and shimmer rates may be used. Alternatively, questions may be asked to a user in order to identify them. Alternatively, other biometric information may be collected which is used to verify the identity of the user. For example, heart rate variability such as is detected with a pulse oximeter or heart rate sensor may be used to verify the identity of the user. Other pulse oximeter or heart rate data may be used. Thus, biometric data from the earpiece may be used to secure payment or otherwise authenticate a user in a manner that is not inconvenient to a user.

The user may then be directed to a location associated with a vehicle such as a current location of the vehicle or a rendezvous location where the user will be picked up. The rendezvous location may be a different location than where the vehicle is currently located and may be a different location from where the user is currently located. The user may be directed through turn-by-turn directions through the earpiece. Thus, the user may be directed to the vehicle. Alternatively, the vehicle may be directed to the individual. For example, if the vehicle is autonomous, it may drive itself to the location of the individual or to a nearby location of the vehicle and then direct the user to the vehicle location. If the vehicle is being driven by someone else, the individual may be directed to the vehicle. The instructions may be turn-by-turn instructions to be followed by the user.

Access to the vehicle may be performed using the biometric data. Thus, the biometric data may be used for making a reservation or purchase. In addition, once the vehicle is in close proximity to the user, the biometric data may be used to authenticate the user to allow the user to open a door of the car or otherwise access the vehicle or vehicle functions.

Various methods, system, and apparatus have been shown and described relating to vehicles with wearable integration or communication. The present invention is not to be limited to these specific examples but contemplates any number of related methods, system, and apparatus and these examples may vary based on the specific type of vehicle, the specific type of wearable device, and other considerations.

What is claimed is:

1. A method comprising steps of:
receiving at an earpiece a request for a vehicle from a user;
verifying identity of the user, the verifying performed by the earpiece;
communicating over a network the request to a vehicle or vehicle operator;
wherein the earpiece comprises an earpiece housing, an intelligent control system disposed within the earpiece; a wireless transceiver disposed within the earpiece and operatively connected to the intelligent control system, at least one speaker operatively connected to the intelligent control system, and at least one microphone operatively connected to the intelligent control system.

2. The method of claim 1 wherein the request for the vehicle is a request to rent a vehicle.

3. The method of claim 1 wherein the request for the vehicle is a request to be picked up by the vehicle.

4. The method of claim 1 wherein the vehicle is an autonomous vehicle.

5. The method of claim 1 wherein the verifying the identity is performed using biometric data collected using one or more sensors of the earpiece.

6. The method of claim 5 wherein the biometric data includes biometric data sensed with a heart rate sensor of the earpiece.

7. The method of claim 6 wherein the biometric data includes heart rate variability.

8. The method of claim 5 wherein the biometric data includes biometric data sensed with a pulse oximeter of the earpiece.

9. The method of claim 1 further comprising providing turn-by-turn directions to the user through the earpiece.

10. The method of claim 1 wherein the receiving the request is receiving a voice request.

11. A method comprising:
detecting at an earpiece, a voice request from a user of the earpiece for access to a vehicle, the earpiece comprising an ear piece housing, at least one microphone, and at least one speaker, an intelligent control system disposed within the ear piece housing and operatively connected to the at least one microphone and the at least on speaker, and a wireless transceiver operatively connected to the intelligent control system;
verifying an identity of the user, wherein the verifying the identify is performed by the earpiece using the intelligent control system;
sending a request from the earpiece over a network, the request including the identity of the user and a user location;
receiving over the network a location associated with the vehicle;
providing audio prompts through the earpiece to direct the user along a path to the location associated with the vehicle from the user location.

12. The method of claim 11 wherein the vehicle is an autonomous vehicle and wherein the location associated with the vehicle is a rendezvous location between the user and the autonomous vehicle.

13. The method of claim 11 wherein the vehicle is a ride share vehicle and wherein the location associated with the vehicle is a rendezvous location between the user and the ride share vehicle.

14. The method of claim 11 wherein the vehicle is a rental vehicle and wherein the location associated with the vehicle is a rendezvous location between the user and the rental vehicle.

15. The method of claim 11 wherein the vehicle is a taxi and wherein the location associated with the vehicle is a rendezvous location between the user and the taxi.

16. The method of claim 11 wherein the location is a rendezvous location between the user and the autonomous vehicle, the rendezvous location being different from a current location of the vehicle.

17. The method of claim 11 wherein the path is at least partially within a building and wherein the earpiece further comprises at least one inertial sensor disposed within the earpiece housing and operatively connected to the intelligent control system.
